(19) United States
(12) Patent Application Publication
(10) Pub. No.: US 2017/0116616 A1
(43) Pub. Date: Apr. 27, 2017

(54) PREDICTIVE TICKETS MANAGEMENT

(71) Applicant: International Business Machines Corporation, Armonk, NY (US)

(72) Inventors: Alessandro Donatelli, Roma (IT); Luigi A. Savorana, Roma (IT); Antonio M. Sgro, Fiumicino (IT); Stefano Sidoti, Rome (IT)

(21) Appl. No.: 14/923,487

(22) Filed: Oct. 27, 2015

(51) Int. Cl. G06Q 30/00; G06N 5/02

(52) U.S. Cl. CPC G06Q 30/016; G06N 5/022

(57) ABSTRACT

A method is provided to inspect an open, on-going customer ticket and guide a support team for taking the best action at the best timing. The method involves a customer product historical graph (CPHG) that is generated based on the closed tickets. The CPHG comprises a plurality of graph node chains, and each node of the graph node chains corresponds to an action that is taken when a ticket is handled, also a set of parameters associated with the action.

### BACKGROUND

The present invention relates generally to the field of customer support, and more particularly to ticket management.

Customer support is a range of customer services to assist customers in making cost effective and correct use of a product and/or service. Customer service is the provision of service to customers before, during and after a purchase, which vary by product, service, industry and individual customer. The customer support usually involve troubleshooting problems or providing guidance about products and/or services such as computers, electronic equipment, food, apparel, or software, which may be done through various channels such as toll-free numbers, websites, instant messaging, or email.

As an important component of customer support, ticket tracking or management manages and maintains lists of issues, as needed by an organization, which is used to create, update, and resolve reported customer issues. A ticket should include vital information for the account involved and the issue encountered. Ticket management often contains a knowledge base containing information on each customer, resolutions to common problems, and other such data.

### SUMMARY

In one aspect of the present invention, a method, a computer program product, and a system includes: identifying a set of closed tickets; sorting the set of closed tickets in a chronological order, wherein a most recent closed ticket is ordered first; generating a customer product historical graph based on the sorted set of closed tickets; and analyzing an open ticket based on the customer product historical graph.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a first method performed, at least in part, by the first embodiment system;

FIG. 3 is a schematic view of a machine logic (for example, software) portion of the first embodiment system;

FIG. 4 is a flowchart showing a second method according to some embodiments of the present invention;

FIG. 5 is an example customer product historical graph generated using the second method; and

FIG. 6 is a flowchart showing a third method according to some embodiments of the present invention.

### DETAILED DESCRIPTION

Some embodiments of the present invention provide a method of predictively analyzing an open ticket based on a customer product historical graph (CPHG). The CPHG is a multidimensional graph and is generated by parsing the closed customer tickets. In addition, the CPHG is customer related, product related, context aware, and a continuously updated knowledge base. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

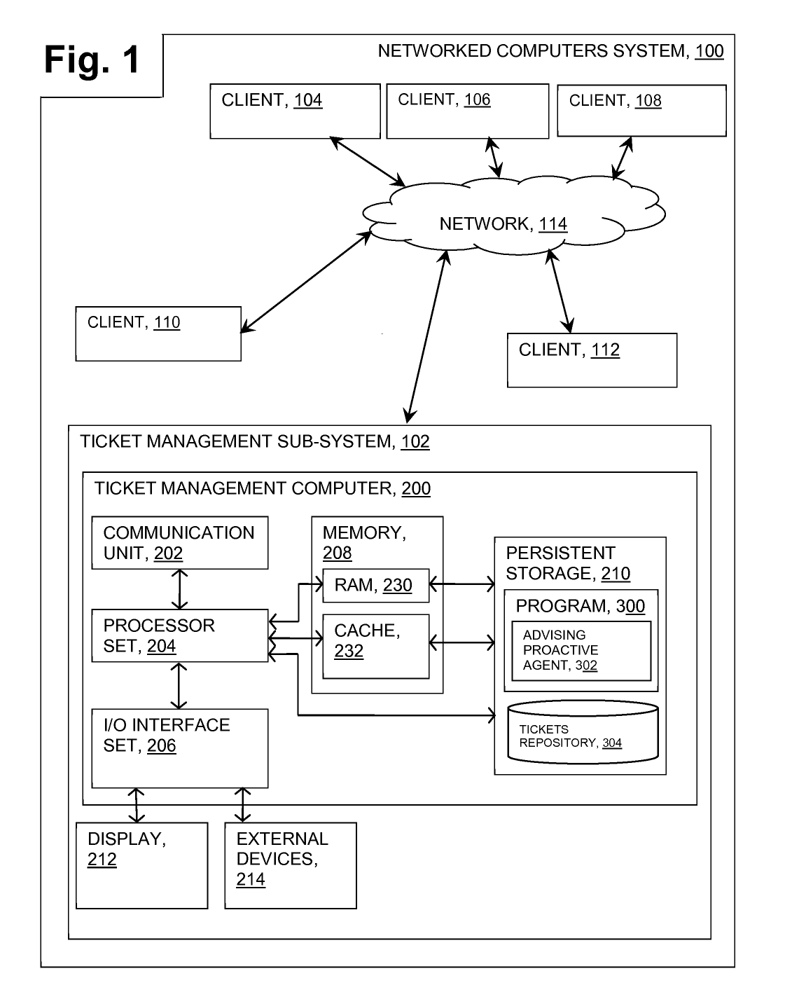

The present invention will now be described in detail with reference to the Figures. FIG. 1 is a functional block diagram illustrating various portions of networked computers system 100, in accordance with one embodiment of the present invention, including: ticket management sub-system 102; client sub-systems 104, 106, 108, 110, 112; communication network 114; ticket management computer 200; communication unit 202; processor set 204; input/output (I/O) interface set 206; memory device 208; persistent storage device 210; display device 212; external device set 214; random access memory (RAM) devices 230; cache memory device 232; program 300; advising proactive agent 302; and tickets repository 304.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Program 300 operates to synthesize a graph representation of historical/old closed tickets which is referred to as customer product historical graph (CPHG) made of graph nodes. Each graph node holds and displays necessary information including action type and timing and associated parameters. The CPHG may be generated using an advising proactive agent 302 by retrieving the closed tickets from a tickets repository 304. Further, program 300 matches a real time/open on-going ticket with the CPHG and provides proper advices for the customer who makes the open ticket request or the support team working on the open ticket based on the matching.

Some embodiments of the present invention recognize the following facts, potential problems and/or potential areas for improvement with respect to the current state of the art: (i) no tools are available for inspecting older tickets related to a certain customer; (ii) no tools are available for tailoring the older tickets for a certain country or other paradigms; (iii) no tools are available for extrapolating from the history of older tickets a predictive analysis on what future actions may be or not be positive for a customer; and/or (iv) a comprehensive and automated method and system is needed to provide a quick and easy inspection of an open, on-going customer request/tickets and guide the support team for the best action to take and the best timing.

When dealing with problem requests coming from a customer, a system should be able to answer to the most important question that arises, for example, “what do I need to do next?” Sometimes it is not clear what kind of action to take for a customer support team for several reasons including: (i) insufficient time to do what is needed; (ii) lack of skilled resources; and/or (iii) unclear problem statement. In most cases, something must be done, but choosing a wrong option may lead to a critical situation, escalation by customers, and/or disputes with customers, which results in financial impacts for the service organization.

Although there are many conventional systems available to manage problems tracking and related requests by customers, a system and method is needed to inspect closed tickets that are created in response to problems requests by to a certain customer, and to make predictive analysis of an open ticket bases on the inspection of closed tickets, for example, what time is better to provide an action to the support team, the deadline to avoid negative feedback from the customer, and so forth.

In some embodiments of the present invention, a comprehensive and automated method and system is provided to connect to an available ticket tracking tool to analyze open tickets and advise for the possible wrong actions, the wrong actions consequences for the customer mood, or possible problems resulting from taking too much time on making actions (for example, by basing on previous experiences).

Further, provided is an integrated method for determining the best, or least negative, action that a customer support team could take when responding to a customer request.

In some embodiment of the present invention, a software agent, referred to as advising proactive agent (APA), is applied that is installed on top of any available tool responsible for managing customer requests/ticket tracking. The APA is responsible for parsing the closed customer tickets and generating a multidimensional graph called customer product historical graph (CPHG). The CPHG is customer related, product related, context aware and continuously updated knowledge base that will be used every time when a customer question arises, for example, what do I need to do next? In such cases, on demand or automatically prompted by the system (program 300 in FIG. 1), the APA is able to provide an advice for, what kind of action is better for the support team to perform to have the best chance to come to a positive result, and/or what actions have caused in the past a negative result.

In some embodiments of the present invention, the timing and the types of actions that may be performed by a customer support team are taken into account, summarizing and grouping them into flexible categories that may be changed or improved by the support team, depending on their specific operational characteristics (such as different kinds of support performed).

Further, in some embodiments of the present invention, variables or parameters (that a system considers as important for success or failure of any customer request/ticket) are taken into account. The parameters are flexible and configurable, such that any number of parameters/variables that the support team may be interested in are applicable. The parameters include, but not limited to, the timing (i.e., how much time passed for an action to be taken), the action type (such as log requests, temporary fixes, and so on), the action owner (i.e., who takes the action) and/or the customer mood (for example, how much the customer is satisfied with the current level of support).

By taking all of the above information into consideration when analyzing closed tickets, a continuously updated CPHG may be created, in which all the parameters are consolidated in a useful graphical model, which may be useful for consultation and/or reporting.

In some embodiments of the present invention, each time when a problem request ticket is closed, the APA parses it and updates the CPHG accordingly. Further, each time the support team becomes interested in different or additional parameters that might influences the organization's business (for example, the number of people of the organization that are working with the customer), a plug-in for each of the different or additional parameter is dynamically added to the APA without affecting the normal function of the APA.

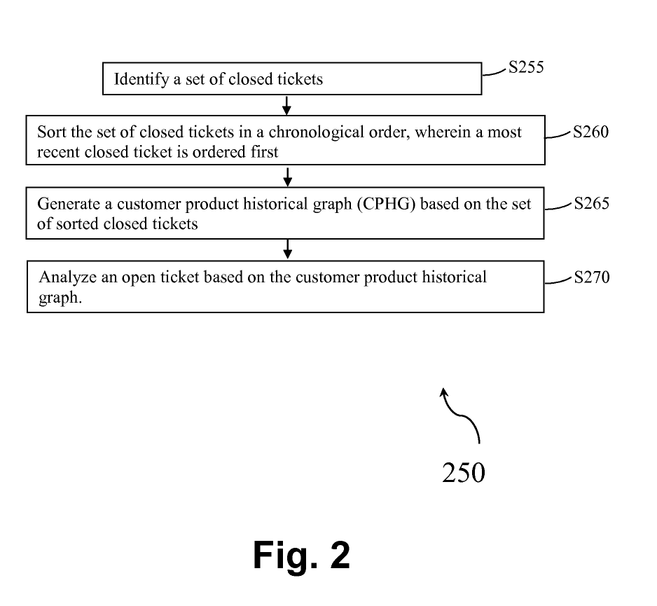

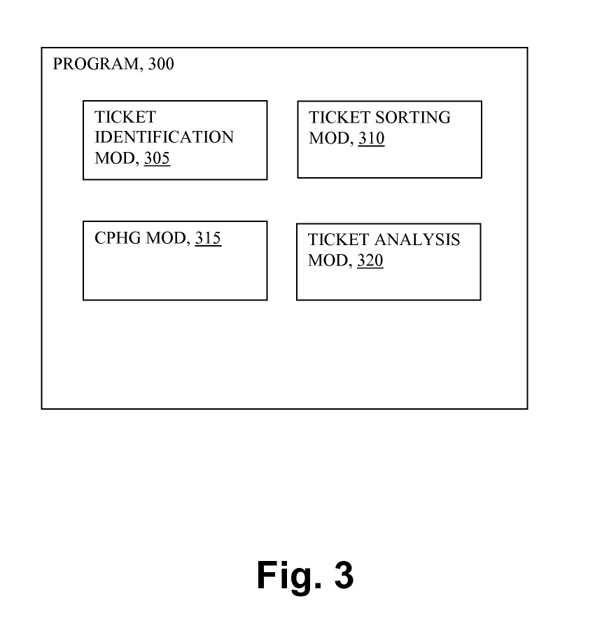

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where ticket identification module (“mod”) 305 identifies a set of closed tickets. In this example, the closed tickets are retrieved from tickets repository 304 in FIG. 1 where the past closed tickets are stored.

Processing proceeds to step S260, where ticket sorting module 310 sorts the set of closed tickets in a chronological order. In this example, the set of closed tickets are sorted based on the time when the tickets are closed, that is, a most recent closed ticket is ordered first.

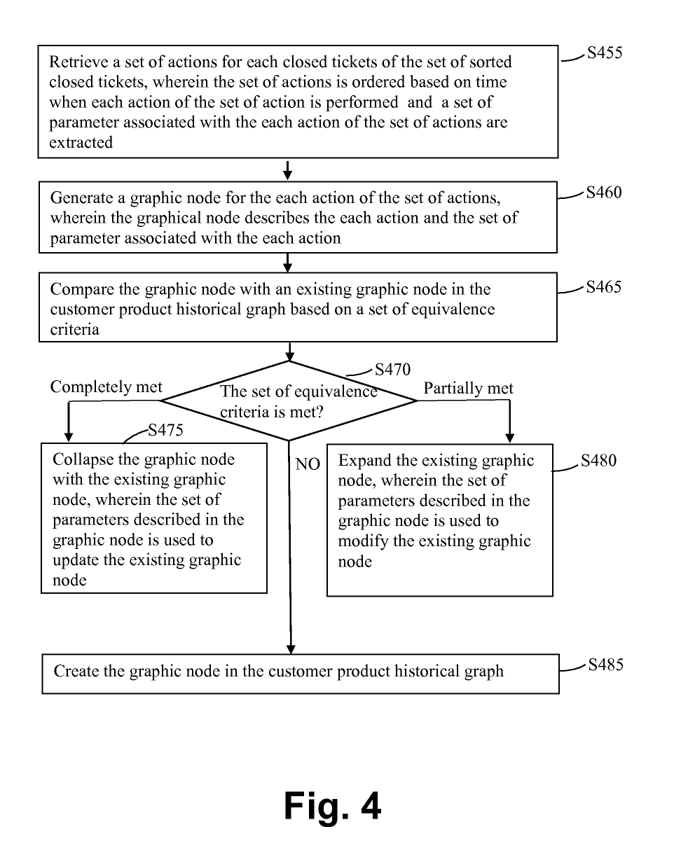

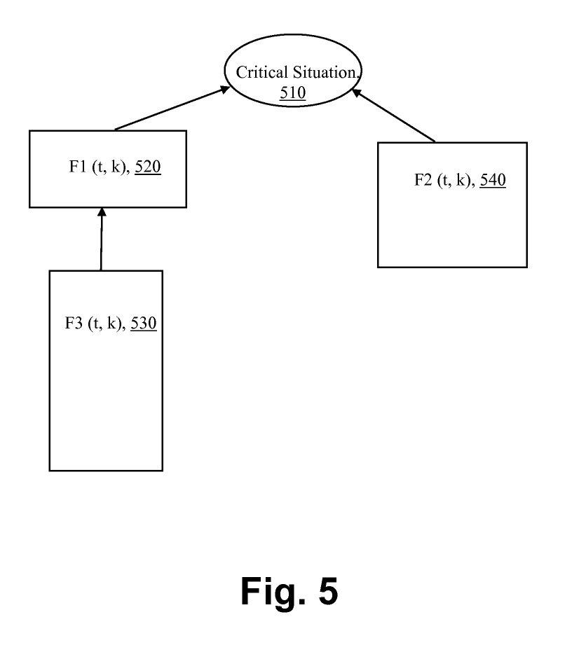

Processing proceeds to step S265, where a customer product historical graph (CPHG) module 315 generates a CPHG based on the sorted closed tickets. In this example, the CPHG is synthesized to be a graph representation of historical closed tickets made of a plurality of graph nodes. The details of synthesizing the CPHG will be described in the followings in FIGS. 4 and 5.

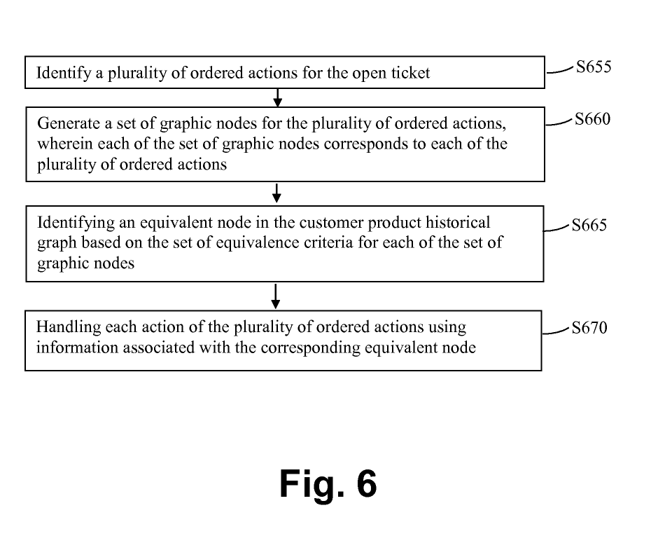

Processing ends at step S270, where ticket analysis module 320 analyzes an open ticket based on the customer product historical graph . . . In this example, analysis of the open ticket based on the CPHG is used to drive the customer support and manage the tickets, to take the right action and to reach to the final solution of a customer problem avoiding an escalation of the problem. Details of analysis of the open ticket will be discussed in the following in FIG. 6.

Details of generating a CPHG is discussed in the paragraphs that follow and later with reference to FIGS. 4-5. FIG. 4 shows a flowchart of generating the CPHG, and FIG. 5 is an example CPHG generated using the method flowchart in FIG. 4.

In step S455 in FIG. 4, a set of actions for each closed tickets of the set of sorted closed tickets are retrieved. The set of actions is ordered based on time when each action of the set of action is performed and a set of parameter associated with the each action of the set of actions are extracted as well. In this example, the advising proactive agent (APA)a synthesis phase in which the APA parses closed problem tickets, having a plug-in manager locate every single action of closed tickets and invoking each plug-in to acquire specific parameter information. The plug-in manager is contained in the APA and there is one plug-in for each parameter. The synthesis process starts with the ticket that is closed most recently, which is crucial for building a correct CPHG and identifying common paths with other tickets (a path is sequence of graphic nodes in the CPHG).

For example, as shown in FIG. 5 of an example of a CPHG, there exists two closed tickets that are handled regarding a customer critical situation (510 in FIG. 5) for a given customer/product or whatever subset of tickets that are taken into account (i.e., the tickets are filtered by a chosen criteria) . A first ticket comprises two actions (i.e., action types 520 and 530); a second ticket comprises just one type of action (action type 540). In FIG. 5, the plug-in manager handles two plug-ins: a time plug-in (t dimension) and a customer mood plug-in (k dimension).

Step S460 in FIG. 4 generates a graphic node for the each action of the set of actions. The graphical node describes the each action (i.e. action type) and the set of parameter associated with the each action. In this example, the APA consolidate information about each action of a closed ticket. Upon the completion of parsing each action, the APA provides a single graphic node fully describing the action for the purposes of the system. The graphic node is the representation of an action taken in a ticket, thus having a timestamp and can be ordered. In FIG. 5, the first ticket has two graphical nodes (nodes 520 and 530) corresponding to two actions in the first ticket, and the two nodes are in temporal sequence to form a node chain (node 520 is more recent than node 530). Within each single action graph node the parameter values reported by the two plug-ins are tracked, and the minimum and maximum values of the two parameters form a rectangle (bi-dimensional node). A rectangle with a different edge length and width defines different value ranges of the parameters, for example, the rectangle for node 520 is different from the rectangle for node 530. The functions F1 (t,k), F2 (t,k), and F3 (t, k) represent the statistical distribution of the values of t and k between the minimum value and the maximum value, respectively.

In step S465 in FIG. 4, the graphic node created in step S460 is compared with an existing graphic node in the CPHG based on a set of equivalence criteria. In this example, the APA matches the graphic node with another graph node in the CPHG following the set of equivalence criteria. A new graph node in the CPHG is said to be equivalent (that is, leading to same results) to another existing node when: the action type is the same; the following (more recent) graph nodes are equivalent; the set of parameters for the new graph node fall into the range already significant for the existing node. Herein “significant” means the range of the set of parameter for the new node are between the minimum and maximum values of the existing node. A new graph node in the CPHG is said to expand another existing node when: (i) the action type is the same; (ii) the following (more recent) graph nodes are equivalent; and/or (iii) the set of parameters for the new graph do not fall into the range already significant for the existing node.

If the set of criteria are fully met in step S470, the graphic node collapses with the existing graphic node in step S475, and the set of parameters described in the graphic node is used to update the existing graphic node. For example, in FIG. 5 for node 530, every time a further action of the same type is inserted into the system, it is evaluated by the APA and matched with node 530, giving that all the preceding (more recent) nodes are equivalent. In this case, to be matched with the node 530, the further action needs to follow another action which is equivalent to the node 520 (more recent node than node 530). Once this pre-requisite is satisfied, the values for the two dimensions (i.e., t and k) associated with the further action are extracted from the APA and matched with the significant interval of node 530. If the match is positive, the further action falls into the existing node (i.e., node 530), and the function F3 is updated as a consequence to represent the updated probability to lead to the critical situation. In this example of FIG. 5, this kind of match can be performed graphically: if the new rectangle (or, in general, multi-dimensional polygon) is contained in the existing node in the CPHG, then the match is positive.

If the set of criteria are partially met in step S470, the existing graphic node is expanded by the graphic node in step S480, and the set of parameters described in the graphic node is used to modify the existing graphic node. That is, the significant values range of the existing node takes account into the set of parameter of the graphic node to update the existing node statistics.

If the set of criteria are not met in step S470, the graphic node is created into the CPHG, linked to the previous (more recent) one to form a node chain in step S485.

Once last action of a closed ticket is analyzed, the nodes chain for this closed ticket is complete and next closed ticket parsing is started, till completion. From this point the synthesis phase is completed, the CPHG is made available for consultation/reporting and for predictive analysis on on-going requests tickets.

The predictive analytic phase is at this point quick and simple. For a given open request ticket, the nodes chain is built following same procedure as described before, then last (more recent) node is considered for an equivalence match into the CPHG. If an equivalent node is found, the statistics already contained into the equivalent CPHG graph node will be used to answer the requested predictive information for the given open ticket.

FIG. 6 shows a flowchart depicting a method of analyzing an open ticket based on a customer product historical graph generated using the method in FIG. 4.

Step S655 identifies a plurality of ordered action for an open ticket. In step S660, a set of graphic nodes are generated for the plurality of ordered actions, wherein each of the set of graphic nodes corresponds to each action of the plurality of ordered. Step S66 identifies an equivalent node in the customer product historical graph (CPHG) based on the set of equivalence criteria for each of the set of graphic nodes, and herein the CPHG is already built based on closed tickets as described before. As mentioned, each node of the CPHG holds and displays the necessary information to match a real time/open ticket and provides proper advice for the open ticket. Upon identification of an equivalent node in the CPHG, each action of the plurality of ordered actions is handled using information associated with the corresponding equivalent node in step S670. For example, in FIG. 5, within the analysis phase, if an action for an open ticket has already been performed and it falls into the node 530, then function F3 is used to provide the updated probability for each of the following, already represented actions (in this case just one: node 520, but could be any number of nodes in other cases) to lead to the critical situation for every value of the coordinates (t and k dimensions).

Some embodiments of the present invention may include one, or more, of the following features, characteristics and/or advantages: (i) inspecting old/closed tickets related to a certain customer; (ii) filtering the information of closed tickets by country or other customer parameters for predictive analysis; (iii) providing a quick and easy way for inspecting an open, on-going customer tickets; and/or (iv) using a customer product historical graph (CPHG) that is dynamically updated.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
identifying a set of closed tickets;
sorting the set of closed tickets in a chronological order, wherein a most recent closed ticket is ordered first;
generating a customer product historical graph based on the sorted set of closed tickets; and
analyzing an open ticket based on the customer product historical graph.

2. The method of claim 1, wherein the step of generating a customer product historical graph based on the sorted set of closed tickets, includes:
retrieving a set of actions for a closed ticket of the sorted set of closed tickets and a set of parameters associated with the set of actions;
sorting the set of actions in a chronological order according to an action performance metric;
generating a graphic node for an action of the set of actions, wherein the graphical node describes the action and the set of parameters associated with the action;
comparing the graphic node with an existing graphic node in the customer product historical graph based on a set of equivalence criteria; and
collapsing the graphic node with the existing graphic node if the set of equivalence criteria are met, wherein the set of parameters described in the graphic node is used to update the existing graphic node to an updated graphic node.

3. The method of claim 2, wherein the step of generating a customer product historical graph based on the sorted set of closed tickets, further includes:
expanding the existing graphic node if the set of equivalence criteria are partially met, wherein the set of parameters described in the graphic node is used to modify the existing graphic node to generate a modified graphic node; and
creating a new graphic node based on the graphic node if the set of equivalence criteria are not met, the new graphic node being created in the customer product historical graph.

4. The method of claim 3, wherein the step of creating a new graphic node based on the graphic node includes:
linking the graphic node to a pre-defined node in the customer product historical graph, wherein the node is created from a prior action of the set of actions; and
forming a node chain in the customer product historical graph.

5. The method of claim 2, wherein the set of parameters includes a member of the group consisting of:
a time that a corresponding action is initiated;
a type of the corresponding action;
an owner of the corresponding action;
a customer mood, and
a count of members of a support team.

6. The method of claim 2, wherein the set of equivalence criteria includes a member of the group consisting of:
a same action type,
a same prior graph node, and
a range of a parameter of the set of parameters associated with the graphic node being in range of a corresponding parameter of a set of corresponding parameters associated with the existing graphic node.

7. The method claim 1, wherein the step of analyzing the open ticket based on the customer product historical graph, includes:
identifying a plurality of ordered actions for the open ticket;
generating a set of graphic nodes respectively corresponding to the plurality of ordered actions;
identifying an equivalent node in the customer product historical graph based on a set of equivalence criteria corresponding to a graphic node of the set of graphic nodes; and
handling an action of the plurality of ordered actions using information associated with the identified equivalent node.

8. A computer program product comprising a computer readable storage medium having a set of instructions stored therein which, when executed by a processor, causes the processor to analyze an open ticket by:
identifying a set of closed tickets;
sorting the set of closed tickets in a chronological order, wherein a most recent closed ticket is ordered first;
generating a customer product historical graph based on the sorted set of closed tickets; and
analyzing an open ticket based on the customer product historical graph.

9. The computer program product of claim 8, wherein generating a customer product historical graph based on the sorted set of closed tickets, includes:
retrieving a set of actions for a closed ticket of the sorted set of closed tickets and a set of parameters associated with the set of actions;
sorting the set of actions in a chronological order according to an action performance metric;
generating a graphic node for an action of the set of actions, wherein the graphical node describes the action and the set of parameters associated with the action;
comparing the graphic node with an existing graphic node in the customer product historical graph based on a set of equivalence criteria; and
collapsing the graphic node with the existing graphic node if the set of equivalence criteria are met, wherein the set of parameters described in the graphic node is used to update the existing graphic node to an updated graphic node.

10. The computer program product of claim 9, wherein generating a customer product historical graph based on the sorted set of closed tickets, further includes:
expanding the existing graphic node if the set of equivalence criteria are partially met, wherein the set of parameters described in the graphic node is used to modify the existing graphic node to generate a modified graphic node; and
creating a new graphic node based on the graphic node if the set of equivalence criteria are not met, the new graphic node being created in the customer product historical graph.

11. The computer program product of claim 10, wherein creating a new graphic node based on the graphic node includes:
linking the graphic node to a pre-defined node in the customer product historical graph, wherein the node is created from a prior action of the set of actions; and
forming a node chain in the customer product historical graph.

12. The computer program product of claim 9, wherein the set of parameters includes a member of the group consisting of:
a time that a corresponding action is initiated;
a type of the corresponding action;
an owner of the corresponding action;
a customer mood, and
a count of members of a support team.

13. The computer program product of claim 9, wherein the set of equivalence criteria includes a member of the group consisting of:
a same action type,
a same prior graph node, and
a range of a parameter of the set of parameters associated with the graphic node being in range of a corresponding parameter of a set of corresponding parameters associated with the existing graphic node.

14. A computer system comprising:
a processor(s) set; and
a computer readable storage medium;
wherein:
the processor set is structured, located, connected, and/or programmed to run program instructions stored on the computer readable storage medium; and
the program instructions which, when executed by a processor, causes the processor to analyze an open ticket by:
identifying a set of closed tickets;
sorting the set of closed tickets in a chronological order, wherein a most recent closed ticket is ordered first;
generating a customer product historical graph based on the sorted set of closed tickets; and
analyzing an open ticket based on the customer product historical graph.

15. The computer system of claim 14, wherein generating a customer product historical graph based on the sorted set of closed tickets, includes:
retrieving a set of actions for a closed ticket of the sorted set of closed tickets and a set of parameters associated with the set of actions;
sorting the set of actions in a chronological order according to an action performance metric;
generating a graphic node for an action of the set of actions, wherein the graphical node describes the action and the set of parameters associated with the action;
comparing the graphic node with an existing graphic node in the customer product historical graph based on a set of equivalence criteria; and
collapsing the graphic node with the existing graphic node if the set of equivalence criteria are met, wherein the set of parameters described in the graphic node is used to update the existing graphic node to an updated graphic node.

16. The computer system of claim 15, wherein generating a customer product historical graph based on the sorted set of closed tickets, further includes:
expanding the existing graphic node if the set of equivalence criteria are partially met, wherein the set of parameters described in the graphic node is used to modify the existing graphic node to generate a modified graphic node; and
creating a new graphic node based on the graphic node if the set of equivalence criteria are not met, the new graphic node being created in the customer product historical graph.

17. The computer system of claim 16, wherein creating a new graphic node based on the graphic node includes:
linking the graphic node to a pre-defined node in the customer product historical graph, wherein the node is created from a prior action of the set of actions; and
forming a node chain in the customer product historical graph.

18. The computer system of claim 15, wherein the set of parameters includes a member of the group consisting of:
a time that a corresponding action is initiated;
a type of the corresponding action;
an owner of the corresponding action;
a customer mood, and
a count of members of a support team.

19. The computer system of claim 15, wherein the set of equivalence criteria includes a member of the group consisting of:
a same action type,
a same prior graph node, and
a range of a parameter of the set of parameters associated with the graphic node being in range of a corresponding parameter of a set of corresponding parameters associated with the existing graphic node.

20. The computer system of claim 14, wherein analyzing the open ticket based on the customer product historical graph, includes:
identifying a plurality of ordered actions for the open ticket;
generating a set of graphic nodes respectively corresponding to the plurality of ordered actions;
identifying an equivalent node in the customer product historical graph based on a set of equivalence criteria corresponding to a graphic node of the set of graphic nodes; and
handling an action of the plurality of ordered actions using information associated with the identified equivalent node.
